(19) United States
(12) Patent Application Publication
(10) Pub. No.: US 2020/0321646 A1
(43) Pub. Date: Oct. 8, 2020

(54) FUEL CELL SYSTEM

(71) Applicant: HONDA MOTOR CO., LTD., Tokyo (JP)

(72) Inventors: Hideharu Naito, Wako-shi (JP); Masahiro Sato, Wako-shi (JP); Satoshi Kasagami, Tokyo (JP)

(21) Appl. No.: 16/836,972

(22) Filed: Apr. 1, 2020

(30) Foreign Application Priority Data
Apr. 5, 2019 (JP) 2019-072813

(51) Int. Cl. H01M 8/2475; B60L 50/72; B60L 50/71

(52) U.S. Cl. CPC H01M 8/2475; H01M 2250/20; B60L 50/71; B60L 50/72

(57) ABSTRACT

In a fuel cell system, a stack case which stores a stack body of power generation cells and an auxiliary device case are separated by a partition wall. An outer periphery of at least one end fluid passage provided at least at the uppermost position, among the fluid passages of the stack body, has an adjacent outer peripheral portion provided adjacent to an outer marginal portion of the stack body. The partition wall includes a facing portion. The facing portion faces an area that lies between the adjacent outer peripheral portion and the stack case and outside the outer marginal portion. At least part of a ventilation connection port configured to connect the inside of the stack case with the inside of the auxiliary device case is provided in the facing portion. The ventilation connection port has a curved shape formed along the adjacent outer peripheral portion.

### CROSS-REFERENCE TO RELATED APPLICATION

This application is based upon and claims the benefit of priority from Japanese Patent Application No. 2019-072813 filed on Apr. 5, 2019, the contents of which are incorporated herein by reference.

### BACKGROUND OF THE INVENTION

### Field of the Invention

The present invention relates to a fuel cell system including a stack case and an auxiliary device case. The stack case stores a stack body having a plurality of power generation cells stacked together. The auxiliary device case stores a fuel cell auxiliary device.

### Description of the Related Art

For example, a solid polymer electrolyte fuel cell includes a membrane electrode assembly (MEA) formed by providing an anode on one surface of an electrolyte membrane, and a cathode on the other surface of the electrolyte membrane. The electrolyte membrane is a polymer ion exchange membrane. A power generation cell is formed by sandwiching the membrane electrode assembly between separators. A plurality of the power generation cells are stacked together to form a stack body. Further, for example, terminal plates, insulating plates, and end plates are stacked on this stack body to form a fuel cell stack.

In use, for example, the fuel cell system including the fuel cell stack of this type is mounted in a mounting space of a fuel cell vehicle, etc. (mounting target). In this case, even if, in particular, a fuel gas which is a hydrogen gas is leaked out of a stack body, etc., it is required to eliminate or reduce the situations where the leaked fuel gas is retained in the mounting space or the like in the vehicle. To this end, for example, Japanese Patent No. 6104864 proposes a fuel cell system where an exhaust duct is connected to the inside of a stack case storing a stack body. In this fuel cell system, the leaked fuel gas in the stack case is guided to a predetermined position such as the outside of the vehicle through the exhaust duct to ventilate the inside of the stack case, whereby leaked fuel gas is prevented from being retained in the mounting space, etc.

### SUMMARY OF THE INVENTION

In this regard, in the fuel cell system, the auxiliary device case which stores therein a fuel cell auxiliary device including an injector, etc. of a fuel gas may be provided adjacent to a stack case. In such a case, it is required to ventilate both of the inside of the stack case and the inside of the auxiliary device case that are separated by a partition wall. For this purpose, for example, the inside of the stack case and the inside of the auxiliary device case are connected respectively to exhaust ducts, and a ventilation connection port is formed in the partition wall for communication between the inside of the auxiliary device case and the inside of the auxiliary device case. In this manner, with the simple structure, it is possible to establish communication between the inside of the stack case, the inside of the auxiliary device case, and the exhaust duct, and thereby perform ventilation thereinside.

In the structure, the leaked fuel gas tends to be retained easily in an area adjacent to the partition wall in the stack case. Therefore, in an attempt of improving the ventilation efficiency of the inside of the stack case and the inside of the auxiliary device case, it may be possible to consider increasing the maximum width of the ventilation connection ports to facilitate smooth flow of the leaked fuel gas between the stack case and the auxiliary device case. However, in the case where the maximum width of the ventilation connection ports is increased, relatively small component parts and/or broken pieces (chips) peeled from constituent components as foreign matters enter the stack case easily from the ventilation connection ports, e.g., at the time of assembling the fuel cell system. In the fuel cell system, in order to suitably maintain the normal operation, it is preferable to suppress entry of the foreign matters into the stack case. Further, there is a concern that, as the maximum width of the ventilation connection port increases, the area of the partition wall becomes large, resulting in the increased sizes of the stack case and the auxiliary device case.

The present invention has been made taking such tasks into account, and an object of the present invention is to provide a fuel cell system in which it is possible to suitably ventilate the inside of a stack case and the inside of an auxiliary device case, suppress entry of foreign matters into the stack case from a ventilation connection port connecting the auxiliary device case with the stack case, and suppress increase in the sizes of the auxiliary device case and the stack case.

In order to achieve the above object, the present invention provides a fuel cell system including a stack case and an auxiliary device case. The stack case is configured to store a stack body including a plurality of power generation cells stacked in a horizontal direction. The auxiliary device case is configured to store a fuel cell auxiliary device. The stack case and the auxiliary device case that are adjacent to each other in the horizontal direction are separated by a partition wall, and an exhaust duct is connected to the inside of the stack case and the inside of the auxiliary device case. The stack body includes a plurality of fluid passages that extend through the stack body in a stacking direction. When fluid passages of the plurality of fluid passages that are provided at least at uppermost position are referred to as end fluid passages, an outer periphery of at least one of the end fluid passages has an adjacent outer peripheral portion provided adjacent to an outer marginal portion of the stack body. The partition wall includes a facing portion configured to face an area that lies between the adjacent outer peripheral portion and an inner wall surface of the stack case and outside the outer marginal portion of the stack body. At least part of a ventilation connection port configured to connect the inside of the stack case with the inside of the auxiliary device case is formed in the facing portion. The ventilation connection port has a curved shape formed along the adjacent outer peripheral portion.

The facing portion of the partition wall faces the area which lies between the adjacent outer peripheral portion of the end fluid passage provided at least at the uppermost position and the inner wall surface of the stack case, and which lies outside the outer marginal portion of the stack body. That is, in the vicinity of the adjacent outer peripheral portion provided at the upper position in the stack case, the facing portion of the partition wall faces the space formed between the outer peripheral surface of the stack body and the inner wall surface of the stack case.

The leaked fuel gas is, in many cases, lighter than the air, and the leaked fuel gas tends to flow upward in the stack case. Further, for example, in particular, in the case where the end fluid passage is a fuel gas passage through which the fuel gas flows, the end fluid passage becomes one of the positions where leakage of the fuel gas can occur. Therefore, the leaked fuel gas tends to be retained in the above space which is at the upper position in the stack case, adjacent the end fluid passage.

At least part of the ventilation connection port is provided in the facing portion of the partition wall, so that at least part of the ventilation connection port can be opened toward the above space. In this manner, by effectively utilizing the above space, it becomes possible to effectively flow the leaked fuel gas occurring adjacent the partition wall in the stack case, from the ventilation connection port into the auxiliary device case, and guide the leaked fuel gas to the exhaust duct, without increasing the maximum width, etc. of the ventilation connection port, and moreover, without increasing the area size of the partition wall.

Further, since the ventilation connection port has the curved shape formed along the adjacent outer peripheral portion of the end fluid passage, the leaked fuel gas from the end fluid passage can efficiently flow into the auxiliary device case through the ventilation connection port.

As a result, it is possible to effectively prevent the leaked fuel gas from being retained even at the position adjacent to the partition wall where the leaked fuel gas tends to be retained relatively easily in the stack case and the auxiliary device case. Therefore, it is possible to suppress increase in the sizes of the stack case and the auxiliary device case, and suitably ventilate the inside of the stack case and the inside of the auxiliary device case.

Further, since the ventilation connection port has the curved shape as described above, it is possible to increase the size of the opening area of the ventilation connection port opened toward the facing portion, without increasing the maximum width of the ventilation connection port. Accordingly, for example, at the time of assembling the fuel cell system, it is possible to eliminate or suppress the situations where foreign matters such as component parts of the fuel cell system, and/or peeled pieces (chips) peeled from the constituent elements of the fuel cell system pass through the ventilation connection port, whereby it is possible to suppress entry of the foreign matters into the stack case.

The above and other objects features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view schematically showing a fuel cell vehicle including a fuel cell system according to an embodiment of the present invention;

FIG. 2 is an exploded perspective view showing a power generation cell;

FIG. 3 is a front view showing an oxygen-containing gas flow field of a first separator stored in a stack case;

FIG. 4 is a front view showing a fuel gas flow field of a second separator stored in the stack case;

FIG. 5 is an exploded perspective view showing a case unit;

FIG. 6 is a cross sectional view schematically illustrating part of the steps of producing the fuel cell system; and

FIG. 7 is a view illustrating the relationship between the shape of an end fluid passage and the shape of a ventilation connection port; and

FIG. 8 is a view illustrating the shape of a ventilation connection port according to a modified embodiment.

### DESCRIPTION OF THE PREFERRED EMBODIMENTS

Preferred embodiments of a fuel cell system according to the present invention will be described in detail with reference to the accompanying drawings. In the drawings, the constituent elements which have the same or similar functions and which offer the same or similar advantages are labeled with the same reference numerals, and description of such constituent elements may not be repeated.

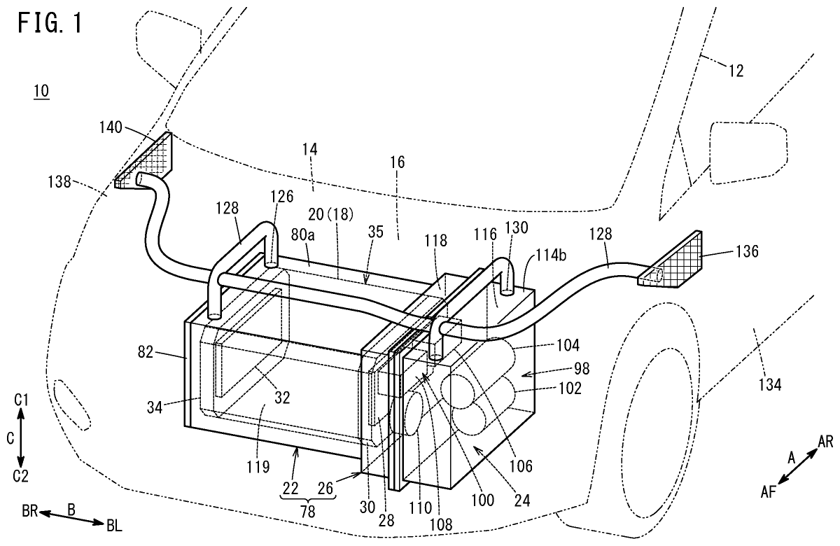

As shown in FIG. 1, an embodiment of the present invention will be described assuming that, as an example, a fuel cell system 10 is mounted in a fuel cell vehicle 12 (mounting target) which is a fuel cell electric automobile. However, the present invention is not limited particularly in this respect. In use, the fuel cell system 10 may be mounted in various mounting targets (not shown). Hereinafter, unless specially noted, a front/rear direction (indicated by an arrow A), a left/right direction (indicated by an arrow B), and an upper/lower direction (indicated by an arrow C) mentioned in the following description are based on a direction viewed from an occupant (not shown) seated on the driver's seat of the fuel cell vehicle 12.

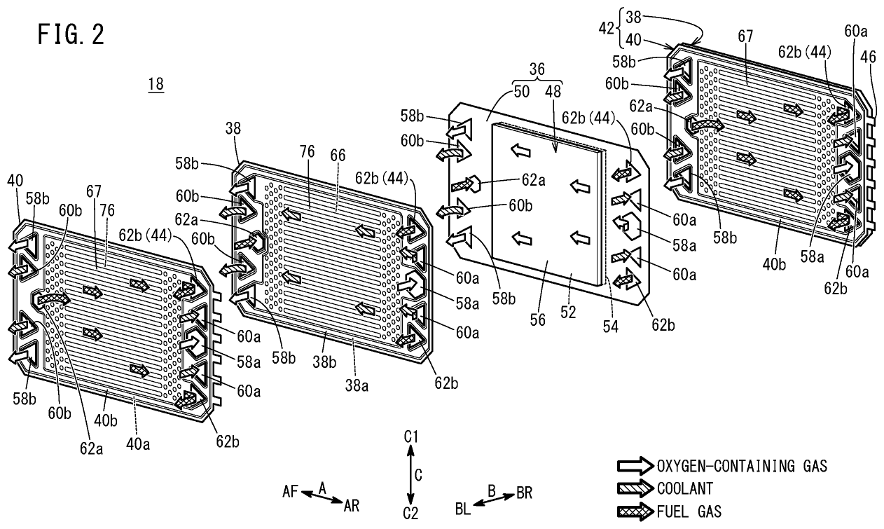

The fuel cell system 10 is provided in a front room (motor room) 16 formed on the front side (indicated by an arrow AF) of a dashboard 14 of the fuel cell vehicle 12. Further, the fuel cell system 10 includes a stack body 20 formed by stacking a plurality of power generation cells 18 (FIG. 2) in a left/right direction (indicated by an arrow B), a stack case 22 storing the stack body 20, and an auxiliary device case 26 storing a fuel cell auxiliary device 24.

Hereinafter, unless specifically noted, it is assumed that the fuel cell system 10 is disposed in the fuel cell vehicle 12 in a mounting direction where the stacking direction of the stack body 20 is oriented in the left/right direction (horizontal direction indicated by the arrow B). However, the present invention is not limited in this respect. For example, the fuel cell system 10 may be mounted in the fuel cell vehicle 12 in a mounting direction where the stacking direction of the stack body 20 is oriented in the front/rear direction (horizontal direction indicated by the arrow A).

As shown in FIG. 1, a first terminal plate 28 is stacked on the left end (indicated by an arrow BL) of the stack body 20 in the stacking direction. A first insulating plate 30 is stacked outside the first terminal plate 28. A second terminal plate 32 is stacked on the right end (indicated by an arrow BR) of the stack body 20. A second insulating plate 34 is stacked outside the second terminal plate 32. Hereinafter, a structure where the stack body 20, the first terminal plate 28, the second terminal plate 32, the first insulating plate 30, and the second insulating plate 34 are stacked together is also referred to as the stack 35.

As shown in FIG. 2, the power generation cell 18 includes a resin frame equipped MEA 36, and a first separator 38 and a second separator 40 sandwiching the resin frame equipped MEA 36. Each of the first separator 38 and the second separator 40 is formed by press forming of a metal thin plate to have a corrugated shape in cross section and a wavy shape on the surface. For example, the metal plate is a steel plate, a stainless steel plate, an aluminum plate, a plated steel plate, or a metal plate having an anti-corrosive surface by surface treatment.

Outer ends of the first separator 38 and the second separator 40 are joined together by welding, brazing, crimping, etc. to form a joint separator 42. In the embodiment of the present invention, four corners of each of the rectangular first separator 38 and the rectangular second separator 40 have a shape formed by forming cutouts substantially along the outer periphery of each of oxygen-containing gas passages and fuel gas passages described later (i.e., the corners are chamfered).

At an edge portion of a rear end (indicated by an arrow AR) in a long side direction (indicated by the arrow A) of the second separator 40, a plurality of (six, in the embodiment) cell voltage terminals 46 which protrude toward the further rear side are arranged at intervals in the upper/lower direction (indicated by the arrow C). The cell voltage terminals 46 provided on the second separators 40 of the stack body 20 are connected to a voltage detection apparatus (not shown) selectively. In this manner, it becomes possible to detect the cell voltage of each of the power generation cells 18, or a predetermined number of power generation cells 18 at the time of power generation.

It should be noted that each of the second separators 40 may have one cell voltage terminal 46, or a plurality of, other than six, cell voltage terminals 46. Further, the cell voltage terminal(s) 46 may be provided in the first separator 38, or may be provided in both of the first separator 38 and the second separator 40.

The resin frame equipped MEA 36 includes a membrane electrode assembly (MEA) 48, and a resin frame member 50. The resin frame member 50 is joined to the outer periphery of the membrane electrode assembly 48, and provided around the outer periphery of the membrane electrode assembly 48. The membrane electrode assembly 48 includes an electrolyte membrane 52, an anode 54 provided on one surface (indicated by the arrow BR) of the electrolyte membrane 52, and a cathode 56 provided on the other side (indicated by an arrow BL) of the electrolyte membrane 52.

For example, the electrolyte membrane 52 is a solid polymer electrolyte membrane (cation ion exchange membrane) such as a thin membrane of perfluorosulfonic acid containing water. The electrolyte membrane 52 is interposed between the anode 54 and the cathode 56. A fluorine based electrolyte may be used as the electrolyte membrane 52. Alternatively, an HC (hydrocarbon) based electrolyte may be used as the electrolyte membrane 52.

The anode 54 includes an anode catalyst layer (not shown) joined to one surface (indicated by the arrow BR) of the electrolyte membrane 52, and an anode gas diffusion layer (not shown) stacked on the anode catalyst layer. The cathode 56 includes a cathode catalyst layer (not shown) joined to the other surface (indicated by an arrow BL) of the electrolyte membrane 52, and a cathode gas diffusion layer (not shown) stacked on the cathode catalyst layer.

For example, the anode catalyst layer is formed by porous carbon particles deposited uniformly on the surface of the anode gas diffusion layer together with an ion conductive polymer binder and platinum alloy supported on the surfaces of the porous carbon particles. For example, the cathode catalyst layer is formed by porous carbon particles deposited uniformly on the surface of the cathode gas diffusion layer together with an ion conductive polymer binder and platinum alloy supported on the surfaces of the porous carbon particles.

Each of the cathode gas diffusion layer and the anode gas diffusion layer is formed of an electrically conductive porous sheet such as carbon paper or carbon cloth, etc. A porous layer (not shown) may be provided at least at one of a position between the cathode catalyst layer and the cathode gas diffusion layer and a position between the anode catalyst layer and the anode gas diffusion layer.

As shown in FIG. 2, as a plurality of fluid passages for allowing fluid to flow in the stacking direction (indicated by the arrow B) of the stack body 20, an oxygen-containing gas supply passage 58a, oxygen-containing gas discharge passages 58b, coolant supply passages 60a, coolant discharge passages 60b, a fuel gas supply passage 62a, and fuel gas discharge passages 62b are provided in the stack 35 shown in FIG. 1. Specifically, the plurality of fluid passages extend through the stack body 20 of the stack 35 (FIG. 1), the first insulating plate 30, and the second insulating plate 34 (FIG. 1) in the direction indicated by the arrow B.

Among these fluid passages, the coolant supply passages 60a and the coolant discharge passages 60b are passages for a coolant such as pure water, ethylene glycol, or oil for cooling the power generation cells 18. The oxygen-containing gas supply passage 58a and the oxygen-containing gas discharge passages 58b are passages for the oxygen-containing gas (e.g., the air) as a reactant gas. It should be noted that the oxygen-containing gas supply passage 58a and the oxygen-containing gas discharge passages 58b will also be collectively referred to as the oxygen-containing gas passages. The fuel gas supply passage 62a and the fuel gas discharge passages 62b are passages for a fuel gas such as a hydrogen-containing gas as a reactant gas. It should be noted that fuel gas supply passage 62a and the fuel gas discharge passages 62b will also be collectively referred to as the fuel gas passages.

As shown in FIG. 2, at a marginal portion of a rear end (indicated by an arrow AR) of the joint separator 42 and the resin frame member 50 of each of the power generation cells 18 in the long side direction (indicated by the arrow A), the oxygen-containing gas supply passage 58a, the two coolant supply passages 60a, and the two fuel gas discharge passages 62b are provided. The oxygen-containing gas supply passage 58a, the two coolant supply passages 60a, and the two fuel gas discharge passages 62b extend through the joint separator 42 and the resin frame member 50 in the stacking direction (indicated by the arrow B). The fuel gas is discharged from each of the power generation cells 18 through the fuel gas discharge passages 62b. The oxygen-containing gas is supplied to each of the power generation cells 18 through the oxygen-containing gas supply passage 58a. The coolant is supplied to each of the power generation cells 18 through the coolant supply passages 60a.

These fluid passages are arranged in the upper/lower direction (indicated by the arrow C). Specifically, the oxygen-containing gas supply passage 58a is disposed between the two coolant supply passages 60a that are spaced from each other in the upper/lower direction. One of the two fuel gas discharge passages 62b is disposed above the upper coolant supply passage 60a (on a side indicated by an arrow C1), and the other thereof is disposed below the lower coolant supply passage 60a (on a side indicated by an arrow C2).

At a marginal portion of a front end (indicated by the arrow AF) of the joint separator 42 and the resin frame member 50 of each of the power generation cells 18 in the long side direction, the fuel gas supply passage 62a, the two coolant discharge passages 60b, and the two oxygen-containing gas discharge passages 58b are provided. The fuel gas supply passage 62a, the two coolant discharge passages 60b, and the two oxygen-containing gas discharge passages 58b extend through the joint separator 42 and the resin frame member 50 in the stacking direction. The fuel gas is supplied to each of the power generation cells 18 through the fuel gas supply passage 62a. The coolant is discharged from each of the power generation cells 18 through the coolant discharge passages 60b. The oxygen-containing gas is discharged from each of the power generation cells 18 through the oxygen-containing gas discharge passages 58b.

These fluid passages are arranged in the upper/lower direction. Specifically, the fuel gas supply passage 62a is disposed between the two coolant discharge passages 60b that are spaced from each other in the upper/lower direction. One of the two oxygen-containing gas discharge passages 58b is disposed above the upper coolant discharge passage 60b, and the other thereof is disposed below the lower coolant discharge passage 60b.

In the embodiment of the present invention, among the plurality of fluid passages, the fuel gas discharge passage 62b provided at the uppermost position is referred to as the end fluid passage 44. It should be noted that, as with the fuel gas discharge passage 62b, the oxygen-containing gas discharge passage 58b provided at the uppermost position may be referred to as the end fluid passage 44, or both of the fuel gas discharge passage 62b and the oxygen-containing gas discharge passage 58b provided at the uppermost positions may be referred to as the end fluid passages 44. Further, at least one of the fuel gas discharge passage 62b and the oxygen-containing gas discharge passage 58b provided at the lowermost positions may also be referred to as the end fluid passage 44.

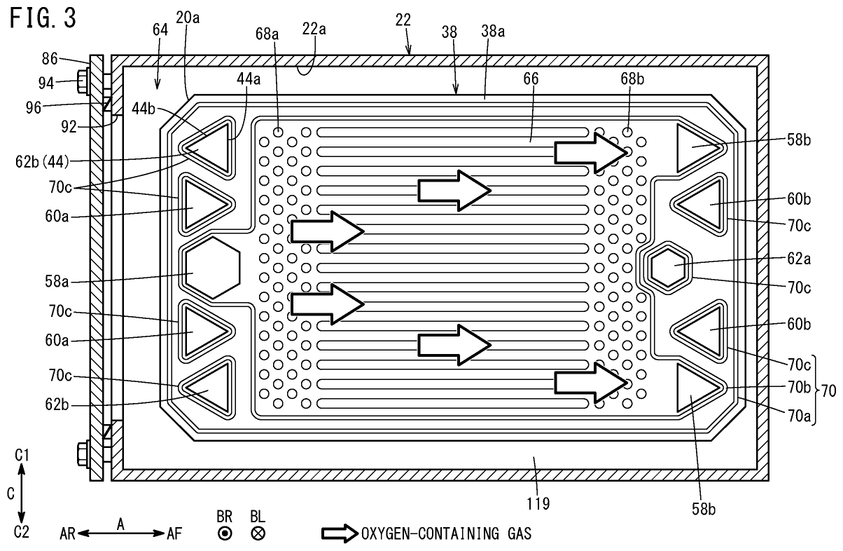

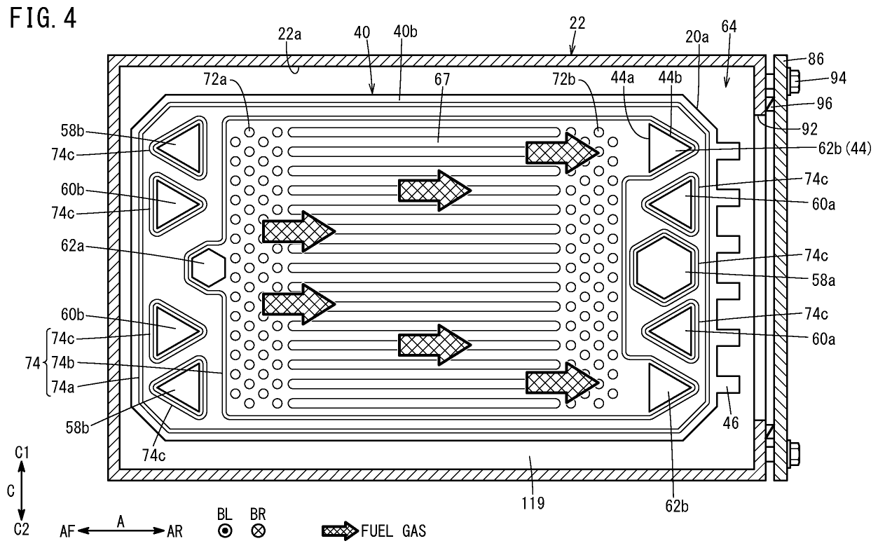

As shown in FIGS. 3 and 4, the outer periphery of the end fluid passage 44 includes an adjacent outer peripheral portion 44b positioned closer to the outer marginal portion 20a of the stack body 20 than the other portion 44a of the outer periphery. A space 64 is formed in an area lying between the adjacent outer peripheral portion 44b and the inner wall surface 22a of the stack case 22 covering the outer periphery of the stack body 20, and outside the outer marginal portion 20a of the stack body 20.

As described above, the four corners of each of the first separator 38 and the second separator 40 have a shape formed by forming cutouts substantially along the outer periphery of each of the oxygen-containing gas passages and the fuel gas passages. That is, the outer marginal portion on the upper side (indicated by the arrow C1) and on the side indicated by the arrow AR of the first separator 38 and the second separator 40 has a shape formed along the adjacent outer peripheral portion 44b of the end fluid passage 44 (the fuel gas discharge passage 62b). Therefore, the space 64 has a large size in comparison with the case where the first separator 38 and the second separator 40 have a rectangular shape without any cutouts.

The layout of the fluid passages is not limited to the embodiment of the present invention, and may be set as necessary depending on the required specification. Unlike the embodiment of the present invention, a pair of the coolant supply passages 60a may be provided on both sides of the fuel gas supply passage 62a in the upper/lower direction (indicated by the arrow C), and a pair of the coolant discharge passages 60b may be provided on both sides of the oxygen-containing gas supply passage 58a in the upper/lower direction. Further, in the embodiment of the present invention, though the two fuel gas discharge passages 62b, the two oxygen-containing gas discharge passages 58b, the two coolant supply passages 60a, and the two coolant discharge passages 60b are provided, alternatively, one fuel gas discharge passage 62b, one oxygen-containing gas discharge passage 58b, one coolant supply passage 60a, and one coolant discharge passage 60b may be provided.

In the present embodiment, the opening area of the oxygen-containing gas supply passage 58a is larger than that of the fuel gas supply passage 62a. As shown in the drawings, for example, the oxygen-containing gas supply passage 58a has a hexagonal shape. Alternatively, the oxygen-containing gas supply passage 58a may have a shape (e.g., quadrangular shape) other than the hexagonal shape. As shown in the drawings, for example, each of the pair of oxygen-containing gas discharge passages 58b has a triangular shape. Alternatively, each of the oxygen-containing gas discharge passages 58b may have a triangular shape rounded at each corner, or a triangular shape chamfered straight at each corner (in effect, hexagonal shape).

As shown in the drawings, for example, the fuel gas supply passage 62a has a hexagonal shape. The fuel gas supply passage 62a has a shape (e.g., quadrangular shape) other than the hexagonal shape. As shown in the drawings, each of the pair of fuel gas discharge passages 62b has a triangular shape. Each of the fuel gas discharge passages 62b has a triangular shape rounded at each corner, or a triangular shape chamfered straight at each corner (in effect, hexagonal shape).

For example, each of the pair of coolant supply passages 60a and the pair of coolant discharge passages 60b has a triangular shape. Each of the pair of coolant supply passages 60a and the pair of coolant discharge passages 60b has a triangular shape including a vertex oriented toward an oxygen-containing gas flow field 66 and a fuel gas flow field 67. Each of the pair of coolant supply passages 60a and the pair of coolant discharge passages 60b may have a triangular shape rounded at each corner, or a triangular shape chamfered straight at each corner (in effect, hexagonal shape). The shapes and the sizes (opening area sizes) of the fluid passages are not particularly limited. The fluid passages may have a circular shape, or any other polygonal shape, etc.

As shown in FIG. 3, the first separator 38 has the oxygen-containing gas flow field 66 on its surface 38a (indicated by the arrow BR) facing the resin frame equipped MEA 36 (FIG. 2). The oxygen-containing gas flow field 66 extends in the front/rear direction (indicated by the arrow A). The oxygen-containing gas flow field 66 is connected to the oxygen-containing gas supply passage 58a and the two oxygen-containing gas discharge passages 58b.

An inlet buffet 68a is provided between the oxygen-containing gas supply passage 58a and the oxygen-containing gas flow field 66 by press forming. The inlet buffer 68a includes a plurality of bosses protruding toward the resin frame equipped MEA 36. An outlet buffer 68b is provided between the oxygen-containing gas discharge passage 58b and the oxygen-containing gas flow field 66 by press forming. The outlet buffer 68b includes a plurality of bosses protruding toward the resin frame equipped MEA 36.

A plurality of metal bead seals 70 are formed on the surface 38a of the first separator 38 by press forming. The metal bead seals 70 are expanded toward the resin frame equipped MEA 36 (FIG. 2). Instead of the metal bead seals 70, a ridge shaped elastic seals made of elastic material may be provided. The plurality of metal bead seals 70 include an outer bead 70a, an inner bead 70b, and a plurality of passage beads 70c. The outer bead 70a is formed around the outer marginal portion of the surface 38a. The inner bead 70b is formed around the oxygen-containing gas flow field 66, the oxygen-containing gas supply passage 58a, and the two oxygen-containing gas discharge passages 58b, while allowing the oxygen-containing gas flow field 66 to be connected to the oxygen-containing gas supply passage 58a and the two oxygen-containing gas discharge passages 58b.

A plurality of passage beads 70c are formed around the fuel gas supply passage 62a, the two fuel gas discharge passages 62b, the two coolant supply passages 60a, and the two coolant discharge passages 60b. The outer bead 70a should be provided as necessary. The outer bead 70a may be dispensed with.

As shown in FIG. 4, the second separator 40 has the fuel gas flow field 67 on its surface 40b (indicated by the arrow BL) facing the resin frame equipped MEA 36 (FIG. 2). For example, the fuel gas flow field 67 extends in the front/rear direction indicated by the arrow A. The fuel gas flow field 67 is connected to the fuel gas supply passage 62a and the two fuel gas discharge passages 62b.

An inlet buffer 72a is provided between the fuel gas supply passage 62a and the fuel gas flow field 67 by press forming. The inlet buffer 72a includes a plurality of bosses protruding toward the resin frame equipped MEA 36 (FIG. 2). An outlet buffer 72b is provided between the fuel gas discharge passage 62b and the fuel gas flow field 67 by press forming. The outlet buffer 72b includes a plurality of bosses protruding toward the resin frame equipped MEA 36.

A plurality of metal bead seals 74 are formed on a surface 40b of the second separator 40 by press forming. The metal bead seals 74 are expanded toward the resin frame equipped MEA 36 (FIG. 2). Instead of the metal bead seals 74, a ridge shaped elastic seals made of elastic material may be provided. The plurality of metal bead seals 74 include an outer bead 74a, an inner bead 74b, and a plurality of passage beads 74c. The outer bead 74a is formed around the outer peripheral portion of the surface 40b. The inner bead 74b is formed inside the outer bead 74a, around the fuel gas flow field 67, the fuel gas supply passage 62a, and the two fuel gas discharge passages 62b, while allowing the fuel gas flow field 67 to be connected to the fuel gas supply passage 62a and the two fuel gas discharge passages 62b.

A plurality of passage beads 74c are formed around the oxygen-containing gas supply passage 58a, the two oxygen-containing gas discharge passages 58b, the two coolant supply passages 60a, and the two coolant discharge passages 60b. The outer bead 74a should be provided as necessary. Alternatively, the outer bead 74a may be dispensed with.

As shown in FIG. 2, a coolant flow field 76 is formed between a surface 38b of the first separator 38 on the side indicated by the arrow BL and a surface 40a of the second separator 40 on the side indicated by the arrow BR that are joined together by welding or brazing. The coolant flow field 76 is connected to the coolant supply passages 60a and the coolant discharge passages 60b. When the first separator 38 and the second separator 40 are stacked together, the coolant flow field 76 is formed between the back surface of the oxygen-containing gas flow field 66 of the first separator 38 and the back surface of the fuel gas flow field 67 of the second separator 40.

As shown in FIGS. 1 and, 5, the stack case 22 and the auxiliary device case 26 are provided adjacent to each other in the left/right direction indicated by the arrow B, and joined together to form a case unit 78. The case unit 78 has a rectangular shape in a plan view, and the long sides of the case unit 78 extend in the vehicle width direction (stacking direction of the stack body 20 indicated by the arrow B).

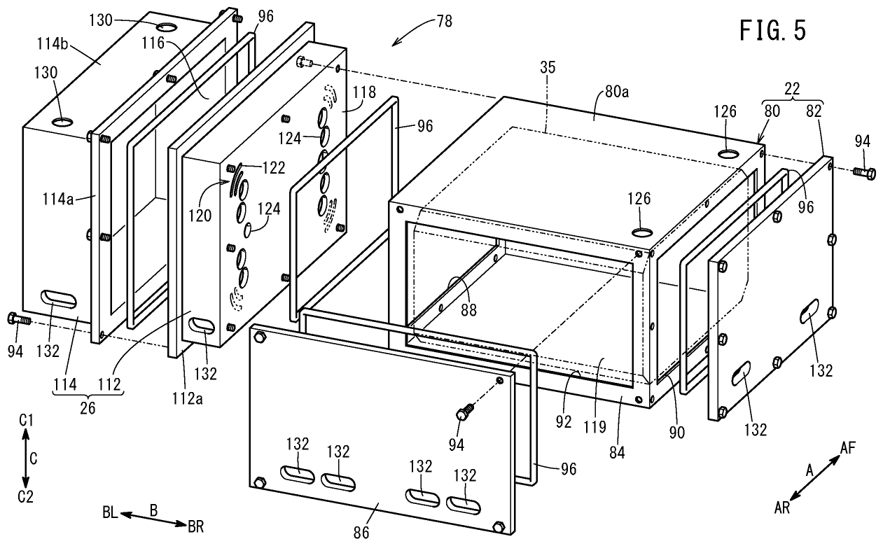

As shown in FIG. 5, the stack case 22 is formed so as to include a peripheral wall case 80 covering the outer peripheral surface of the stack body 20, and an end plate 82 in the form of a rectangular plate having a longitudinal direction oriented in the front/rear direction (indicated by the arrow A). The peripheral wall case 80 includes a case body 84 having a rectangular shape in a plan view, and a rear panel 86. The case body 84 includes a rectangular left opening 88 formed on the left side (in the direction indicated by the arrow BL), a rectangular right opening 90 formed on the right side (in the direction indicated by the arrow BR), and a rectangular rear opening 92 formed on the rear side (in the direction indicated by the arrow AR). The case body 84 has a box shape.

The rear panel 86 is joined to the case body 84 using bolts 94 in a manner to close the rear opening 92. A seal member 96 made of elastic material is interposed between the case body 84 and the rear panel 86, along the outer periphery of the rear opening 92. It should be noted that the rear panel 86 and the case body 84 may be integral with each other, not separate component parts.

The end plate 82 is joined to the case body 84 using bolts 94 in a manner to close the right opening 90. In the structure, the end plate 82 is provided so as to face toward and lie adjacent to the second insulating plate 34 (see FIG. 1) provided at the right end (the end indicated by the arrow BR) of the stack 35 in the case body 84. The seal member 96 made of elastic material is interposed between the case body 84 and the end plate 82, along the outer periphery of the right opening 90.

As shown in FIG. 1, the auxiliary device case 26 is a protection case for storing and protecting the fuel cell auxiliary device 24. The auxiliary device case 26 stores therein, as the fuel cell auxiliary device 24, an oxygen-containing gas system device 98 and a fuel gas system device 100. The oxygen-containing gas system device 98 includes an air pump 102, a humidifier 104, etc. The fuel gas system device 100 includes an injector 106, an ejector 108, a hydrogen pump 110, and valves (not shown).

Specifically, as shown in FIG. 5, the auxiliary device case 26 includes a first case member 112 and a second case member 114 each having a box shape. One end of each of the first case member 112 and the second case member 114 is opened, and flanges 112a, 114a are provided around the openings of the first case member 112 and the second case member 114, respectively. The first case member 112 and the second case member 114 are joined together by fixing the flange 112a of the first case member 112 and the flange 114a of the second case member 114 together using bolts. An auxiliary device storage space 116 storing the fuel cell auxiliary device 24 (see FIG. 1) is formed between the first case member 112 and the second case member 114 that are joined together as described above.

The first case member 112 has a partition wall 118 provided at a right end (the end indicated by the arrow BR) thereof, the partition wall 118 closing the left opening 88. The partition wall 118 is joined to a left end (the end indicated by an arrow BL) of the case body 84 using bolts 94. The partition wall 118 of the auxiliary device case 26 also serves an end plate of the stack case 22. Thus, the partition wall 118 is provided so as to face toward and lie adjacent to the first insulating plate 30 (see FIG. 1) provided at the left end (the end indicated by the arrow BL) of the stack 35 in the case body 84, and applies a tightening load in the stacking direction to the stack 35 between the partition wall 118 and the end plate 82.

Further, in the case unit 78, a stack storage space 119 storing the stack body 20 (stack 35) is formed on the right side of the partition wall 118, and the auxiliary device storage space 116 is formed on the left side of the partition wall 118. That is, the stack case 22 and the auxiliary device case 26 that are adjacent to each other in the left/right direction (stacking direction indicated by the arrow B, horizontal direction) are separated by the partition wall 118.

As shown in FIGS. 5 to 7, the partition wall 118 includes a facing portion 120. The facing portion 120 faces an area which lies between the adjacent outer peripheral portion 44b and the inner wall surface 22a of the stack case 22, as shown in FIGS. 3 and 4, and which is outside the outer marginal portion 20a of the stack body 20, i.e., the facing portion faces the space 64. The facing portion 120 has, formed therein, at least part of the ventilation connection ports 122 connecting the stack storage space 119 inside the stack case 22 with the auxiliary device storage space 116 inside the auxiliary device case 26.

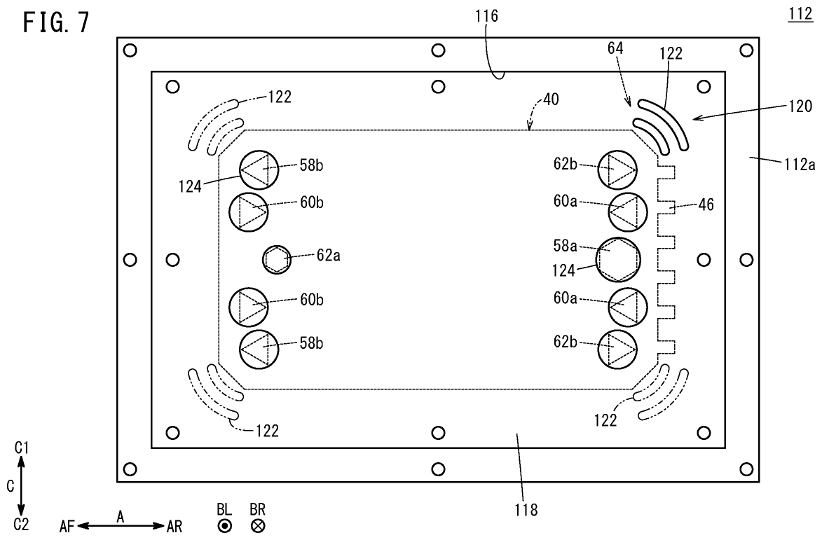

Based on assumption that the oxygen-containing gas discharge passage 58b provided at the uppermost position of the joint separator 42 and the fuel gas discharge passage 62b and the oxygen-containing gas discharge passage 58b provided at the lowermost positions of the joint separator 42 in FIG. 2 are considered as the end fluid passage 44, in FIGS. 5 and 7, the ventilation connection ports 122 provided in portions of the partition wall 118 that serve as the facing portions 120 are denoted by phantom lines. That is, the partition wall 118 may have the ventilation connection ports 122 at positions adjacent to the four corners thereof.

As shown in FIGS. 5 and 7, each of the ventilation connection ports 122 has a curved shape formed along the adjacent outer peripheral portion 44b (FIGS. 3 and 4) as viewed in a left/right direction (as viewed in a direction indicated by an arrow B). Further, a plurality of (two, in the embodiment of the present invention) ventilation connection ports 122 are arranged in parallel at intervals from the adjacent outer peripheral portion 44b toward the outside of the stack body 20. As shown in FIG. 5, the seal member 96 made of elastic material is interposed between the outer peripheral side of the ventilation connection port 122 of the partition wall 118 and the case body 84, along the outer periphery of the left opening 88.

As shown in FIGS. 5 and 7, the partition wall 118 has a plurality of piping openings 124 at positions facing the respective fluid passages provided in the stack 35, connection pipes (not shown) are passed through the respective piping openings 124, and then connected to the corresponding fluid passages. In the structure, it becomes possible to supply the oxygen-containing gas and the fuel gas as the reactant gases and the coolant to the corresponding fluid passages, and discharge the oxygen-containing gas and the fuel gas as the reactant gases and the coolant from the fluid passages, through the respective connection pipes.

As shown in FIGS. 1 and 5, in the case unit 78, peripheral wall through holes 126 penetrate through an upper wall 80a of the peripheral wall case 80, at both ends in the front/rear direction (indicated by the arrow A) of the end (the right end indicated by the arrow BR) opposite to the side where the auxiliary device case 26 is provided, in the left/right direction (indicated by the arrow B. That is, the peripheral wall through holes 126 are provided at right corners of the upper wall 80a of the peripheral wall case 80. As shown in FIG. 1, an exhaust duct 128 is connected to each of the peripheral wall through holes 126. In the structure, the inside of the stack storage space 119 is connected to the inside of the exhaust duct 128.

Further, auxiliary device case through holes 130 penetrate through an upper wall 114b of the second case member 114 of the auxiliary device case 26 at both ends in the front/rear direction (indicated by the arrow A). That is, the auxiliary device case through holes 130 are provided at the left corners of the upper wall 114b of the second case member 114. The exhaust duct 128 is connected to each of the auxiliary device case through holes 130. In the structure, the inside of the auxiliary device storage space 116 is connected to the inside of the exhaust duct 128.

Further, as shown in FIG. 5, in the case unit 78, air can flow into the case unit 78 (the stack storage space 119 and the auxiliary device storage space 116) through ventilation through holes 132 formed so as to penetrate the lower part of the end plate 82, the lower part of the rear panel 86, and the lower part of the side wall of the auxiliary device case 26. It should be noted that the ventilation through holes 132 are not shown in FIG. 1.

The left end of the exhaust duct 128 (the end indicated by the arrow BL) is connected to a left exhaust port 136 provided in a left fender 134 of the fuel cell vehicle 12. Further, the right end of the exhaust duct 128 (the end indicated by the arrow BR) is connected to a right exhaust port 140 provided in a right fender 138 of the fuel cell vehicle 12. That is, the exhaust duct 128 is connected to the outside of the fuel cell vehicle 12 through the left exhaust port 136 and the right exhaust port 140.

In the structure, when leakage of the fuel gas from the stack body 20 and/or the fuel cell auxiliary device 24, etc. occurs, the leaked fuel gas is discharged to the outside of the fuel cell vehicle 12 through the stack storage space 119, the auxiliary device storage space 116, and the exhaust duct 128.

Operation of the fuel cell system 10 having the above structure will be described below. In the fuel cell vehicle 12, power generation by the fuel cell system 10 is performed e.g., during driving of the fuel cell vehicle 12. In this case, the fuel gas is supplied to the fuel gas supply passage 62a (FIG. 2) of the stack 35, the oxygen-containing gas is supplied to the oxygen-containing gas supply passage 58a (FIG. 2) of the stack 35, and the coolant is supplied to the coolant supply passages 60a (FIG. 2) of the stack 35 through the connection pipes as described above.

As shown in FIGS. 2 and 3, the oxygen-containing gas flows from the oxygen-containing gas supply passage 58a into the oxygen-containing gas flow field 66 of the first separator 38. The oxygen-containing gas flows along the oxygen-containing gas flow field 66 in the direction indicated by the arrow B, and is supplied to the cathode 56 of the membrane electrode assembly 48.

In the meanwhile, as shown in FIGS. 2 and 4, the fuel gas flows from the fuel gas supply passage 62a into the fuel gas flow field 67 of the second separator 40. The fuel gas flows along the fuel gas flow field 67 in the direction indicated by the arrow B, and is supplied to the anode 54 of the membrane electrode assembly 48.

In each of the membrane electrode assemblies 48 of the stack body 20, the oxygen-containing gas supplied to the cathode 56 and the fuel gas supplied to the anode 54 are consumed in electrochemical reactions in the cathode catalyst layer and the anode catalyst layer to thereby generate electrical energy in power generation. The electrical energy is utilized to enable the fuel cell vehicle 12 to travel, for example.

As shown in FIG. 2, the oxygen-containing gas supplied to the cathode 56 is consumed at the cathode 56, and then discharged along the oxygen-containing gas discharge passages 58b in the direction indicated by the arrow A. Likewise, the fuel gas supplied to the anode 54 is consumed at the anode 54, and then discharged along the fuel gas discharge passage 62b in the direction indicated by the arrow A.

Further, the coolant supplied to the coolant supply passage 60a flows into the coolant flow field 76 formed between the first separator 38 and the second separator 40, and flows in the direction indicated by the arrow B to cool the membrane electrode assembly 48, etc. Thereafter, the coolant is discharged from the coolant discharge passage 60b in the direction indicated by the arrow A.

As shown in FIGS. 1 and 5, when leakage of the fuel gas from the stack body 20 (stack 35) occurs in the stack storage space 119, some of the leaked fuel gas flows into the exhaust duct 128 through the peripheral wall through holes 126 formed in the upper wall 80a of the peripheral wall case 80. Further, the remaining leaked fuel gas in the stack storage space 119 passes through the ventilation connection ports 122 formed in the partition wall 118, and flows into the auxiliary device storage space 116. Thereafter, the remaining leaked fuel gas flows into the exhaust duct 128 through the auxiliary device case through holes 130 formed in the upper wall 114b of the second case member 114.

Further, in the case where leakage of the fuel gas from the fuel cell auxiliary device 24 occurs in the auxiliary device storage space 116, the leaked fuel gas flows into the exhaust duct 128 through the auxiliary device case through holes 130. It should be noted that, when tilt or the like of the fuel cell vehicle 12 occurs, the leaked fuel gas in the auxiliary device storage space 116 may pass through the ventilation connection ports 122 provided in the partition wall 118 into the stack storage space 119, and then, may flow into the exhaust duct 128 through the peripheral wall through holes 126.

As a result, the leaked fuel gas inside the stack case 22 and the auxiliary device case 26 (the stack storage space 119 and the auxiliary device storage space 116) is discharged to the outside of the fuel cell vehicle 12 through the exhaust duct 128, whereby it is possible to perform ventilation inside the stack case 22 and the auxiliary device case 26.

As described above, in the fuel cell system 10 according to the embodiment of the present invention, the facing portion 120 of the partition wall 118 faces the area which lies between the adjacent outer peripheral portion 44b of the end fluid passage 44 provided at least at the uppermost position and the inner wall surface 22a of the stack case 22, and outside the outer marginal portion 20a of the stack body 20. That is, at least in the vicinity of the adjacent outer peripheral portion 44b provided at the upper position inside the stack case 22, the facing portion 120 faces the space 64 formed between the outer marginal portion 20a of the stack body 20 and the inner wall surface 22a of the stack case 22.

The leaked fuel gas such as the hydrogen-containing gas is lighter than the air, and tends to flow upward in the stack storage space 119. Further, for example, in particular, in the case where the end fluid passage 44 is the fuel gas passage for the fuel gas (the fuel gas discharge passage 62b in the present embodiment), the end fluid passage 44 becomes one of the positions where leakage of the fuel gas may occur. Therefore, the leaked fuel gas tends to be retained in the above space 64 which is at the upper position in the stack case 22 and adjacent to the end fluid passage 44.

At least part of the ventilation connection port 122 is provided in the facing portion 120 of the partition wall 118, so that at least part of the ventilation connection port 122 can be opened toward the above space 64. In this manner, by effectively utilizing the above space 64, it becomes possible to effectively flow the leaked fuel gas occurring adjacent the partition wall 118 in the stack case 22, from the ventilation connection port 122 into the auxiliary device case 26, and guide the leaked fuel gas to the exhaust duct 128, without increasing the maximum width or the like of the ventilation connection port 122, that is, without increasing the area of the partition wall 118.

Further, since the ventilation connection port 122 has the curved shape formed along the adjacent outer peripheral portion 44b of the end fluid passage 44, the leaked fuel gas from the end fluid passage 44 can efficiently flow into the auxiliary device case 26 through the ventilation connection port 122.

As a result, also at the position adjacent to the partition wall 118 where the leaked fuel gas tends to be retained relatively easily in the stack case 22 and the auxiliary device case 26, it is possible to effectively prevent the leaked fuel gas from being retained. Therefore, it becomes possible to suppress increase in the sizes of the stack case 22 and the auxiliary device case 26, and suitably ventilate the inside of the stack case 22 and the inside of the auxiliary device case 26.

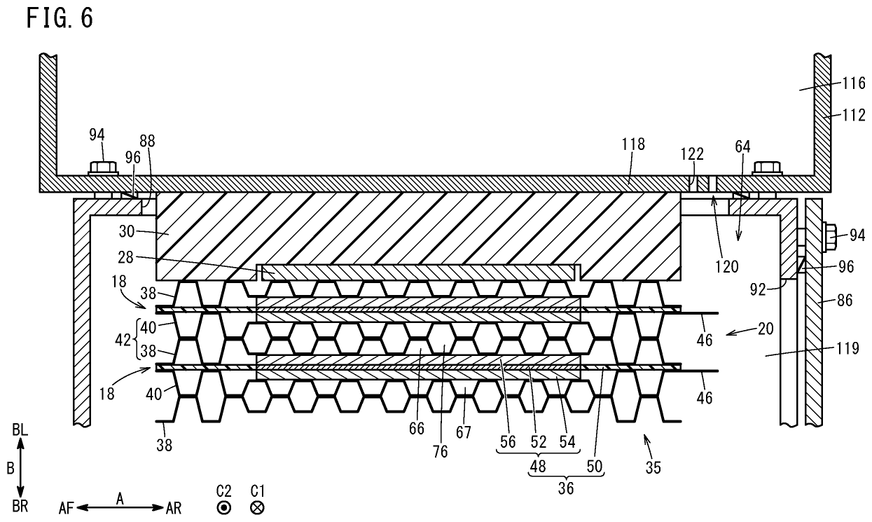

The fuel cell system 10 is produced through an assembling step of joining the stack case 22 and the auxiliary device case 26 together, for example. In this assembling step, as shown in FIG. 6, before joining the stack case 22 and the auxiliary device case 26 together, the stack 35 is stored in the stack case 22. At this time, the orientation of the stack 35 is adjusted in a manner that the first insulating plate 30 of the stack 35 is disposed on the upper side in the vertical direction (i.e., in a manner that the stacking direction of the stack 35 is oriented in the vertical direction).

In this state, the first case member 112 is stacked on the stack case 22, and the stack case 22 and the first case member 112 are joined together using bolts, etc., in a manner that the left opening 88 of the stack case 22 is covered with the partition wall 118. That is, in the assembling step, the ventilation connection ports 122, which face toward and lie adjacent to the stack storage space 119 of the stack case 22, are positioned on the upper side of the stack case 22 in the vertical direction.

Therefore, in the case where circular ventilation connection ports (not shown) having the increased maximum width is provided in the partition wall 118 in an attempt to facilitate ventilation of the inside of the case unit 78, there is a concern that foreign matters may enter the stack case 22 through the ventilation connection ports under the effect of the gravity. Examples of the foreign matters include relatively small parts such as the bolts 94, and peeled pieces (chips) peeled from the stack case 22, etc. at the time of tightening bolts.

In contrast, in the fuel cell system 10 according to the embodiment of the present invention, since the ventilation connection port 122 has the curved shape as described above, it is possible to increase the opening area of the ventilation connection ports 122 opened toward the facing portion 120, without increasing the maximum width of the ventilation connection ports 122. Accordingly, for example, e.g., at the time of assembling the fuel cell system 10, it is possible to eliminate or suppress the situations where foreign matters pass through the ventilation connection ports 122, and suppress entry of the foreign matters into the stack case 22.

Therefore, in the fuel cell system 10 according to the embodiment of the present invention, it is possible to suitably ventilate the inside of the stack case 22 and the inside of the auxiliary device case 26, and suppress entry of foreign matters into the stack case 22 from the ventilation connection ports 122 connecting the auxiliary device case 26 and the stack case 22, and it is also possible to suppress increase in the sizes of the auxiliary device case 26 and the stack case 22.

In the fuel cell system 10 according to the above embodiment, the ventilation connection port 122 comprises a plurality of (two) ventilation connection ports 122 that are arranged in parallel to each other at interval from the adjacent outer peripheral portion 44b to the outside of the stack body 20, and at least part of the plurality of ventilation connection ports 122 is provided in the facing portion 120. In this configuration, it is possible to increase the total opening area of the ventilation connection ports 122 without increasing the maximum width of the ventilation connection ports 122. Therefore, it becomes possible to more suitably ventilate the inside of the stack case 22 and the inside of the auxiliary device case 26, and suppress entry of the foreign matters from the ventilation connection ports 122 into the stack case 22.

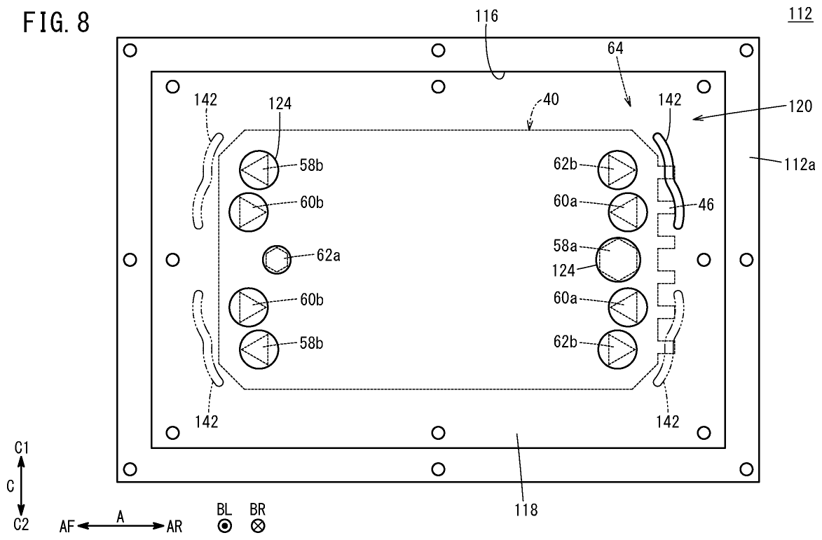

As long as the ventilation connection port 122 has the curved shape formed along the adjacent outer peripheral portion 44b, as viewed in the left/right direction (viewed in the direction indicated by the arrow B), the ventilation connection ports 122 may be formed in the facing portion 120 in any manner. For example, as in the case of ventilation connection ports 142 shown in FIG. 8, the ventilation connection port may have a curved shape formed along both of the outer peripheral portions of the fluid passages (the coolant supply passages 60a or the coolant discharge passages 60b) that are adjacent to the end fluid passage 44 in the upper/lower direction and the adjacent outer peripheral portion 44b.

In the fuel cell system 10 according to the embodiment of the present invention, the ventilation connection port 122 is provided at least at one of both ends in the direction (indicated by the arrow A) perpendicular to the stacking direction, on the upper side in the auxiliary device case 26. In this case, since the ventilation connection port 122 is provided on the upper side in the case unit 78 where the leaked fuel gas tends to be retained, it becomes possible to effectively flow the leaked fuel gas from the ventilation connection port 122 into the auxiliary device case 26, and guide the leaked fuel gas to the exhaust duct 128. As a result, it is possible to improve the ventilating efficiency inside the stack case 22 and the auxiliary device case 26.

The end fluid passages 44 of the fuel cell system 10 according embodiment of the present invention may further include the fluid passage (the oxygen-containing gas discharge passage 58b or the fuel gas discharge passage 62b) provided at the lowermost position, and the ventilation connection port 122 may be provided at least at one of both ends in the direction (indicated by the arrow A) perpendicular to the stacking direction, on the lower side in the auxiliary device case 26. Also in this case, since it is possible to increase the number of the ventilation connection ports 122 formed in the partition wall 118, it is possible to increase the total opening area of the ventilation connection ports 122 without increasing the maximum width of the ventilation connection ports 122. As a result, it becomes possible to more suitably ventilate the inside of the stack case 22 and the inside of the auxiliary device case 26, and suppress entry of the foreign matters from the ventilation connection ports 122 into the stack case 22.

As in the case of the fuel cell system 10 according to the embodiment of the present invention, preferably, at least one of the end fluid passages 44 is the fuel gas passage through which the fuel gas flows. In this case, the ventilation connection port 122 is formed along the adjacent outer peripheral portion 44b of the fuel gas passage where leakage of the fuel gas occurs easily in comparison with the other fluid passages through which the oxygen-containing gas or the coolant flows. Therefore, it is possible to efficiently flow the leaked fuel gas occurring in the case unit 78, into the auxiliary device case 26 through the ventilation connection port 122, and guide the leaked fuel gas to the outside of the vehicle from the exhaust duct 128.

The present invention is not limited to the above described embodiment. It is a matter of course that various modifications can be made without departing from the gist of the present invention.

For example, in the above embodiment, the auxiliary device case 26 is provided at the left end of the stack case 22. Alternatively, the auxiliary device case 26 may be provided at the right end of the stack case 22.

What is claimed is:

1. A fuel cell system comprising a stack case configured to store a stack body including a plurality of power generation cells stacked in a horizontal direction and an auxiliary device case configured to store a fuel cell auxiliary device, the stack case and the auxiliary device case that are adjacent to each other in the horizontal direction being separated by a partition wall, and an exhaust duct being connected to an inside of the stack case and an inside of the auxiliary device case,
wherein the stack body includes a plurality of fluid passages that extend through the stack body in a stacking direction;
when fluid passages of the plurality of fluid passages that are provided at least at uppermost position are referred to as end fluid passages, an outer periphery of at least one of the end fluid passages has an adjacent outer peripheral portion provided adjacent to an outer marginal portion of the stack body;
the partition wall includes a facing portion configured to face an area that lies between the adjacent outer peripheral portion and an inner wall surface of the stack case and outside the outer marginal portion of the stack body;
at least part of a ventilation connection port configured to connect an inside of the stack case with an inside of the auxiliary device case is formed in the facing portion; and
the ventilation connection port has a curved shape formed along the adjacent outer peripheral portion.

2. The fuel cell system according to claim 1, wherein the ventilation connection port comprises a plurality of ventilation connection ports that are arranged in parallel to each other at intervals from the adjacent outer peripheral portion to outside of the stack body, and at least part of the plurality of ventilation connection ports is provided in the facing portion.

3. The fuel cell system according to claim 1, wherein the ventilation connection port is provided at least at one of both ends in a direction perpendicular to the stacking direction, on an upper side in the auxiliary device case.

4. The fuel cell system according to claim 1, wherein the end fluid passages further comprise fluid passages of the plurality of fluid passages that are provided at lowermost position; and
the ventilation connection port is provided at least at one of both ends in a direction perpendicular to the stacking direction, on a lower side in the auxiliary device case.
